(19) United States
(12) Patent Application Publication
(10) Pub. No.: US 2012/0069044 A1
(43) Pub. Date: Mar. 22, 2012

(54) DYNAMIC GAMMA CONTROL METHOD FOR LCD

(75) Inventors: Ming-Lin Lee, Taipei (TW); Feng-Ting Pai, Taipei (TW); Chin-Hung Hsu, Taipei (TW)

(73) Assignee: HANNSTAR DISPLAY CORPORATION, New Taipei City (TW)

(21) Appl. No.: 13/306,957

(22) Filed: Nov. 29, 2011

Related U.S. Application Data
(63) Continuation of application No. 11/393,238, filed on Mar. 30, 2006.

(51) Int. Cl. G09G 3/36; G09G 5/10; G09G 5/02

(52) U.S. Cl. 345/589; 345/690; 345/89

(57) ABSTRACT

A dynamic gamma control method for an LCD is provided. The LCD displays a present frame by a plurality of gamma reference voltages and the present frame includes an R-pixel data sum, a G-pixel data sum and a B-pixel data sum which are obtained by respectively adding all R-pixel data, all G-pixel data and all B-pixel data of at least one pixel of the present frame. The method includes steps of: weighting the R-pixel data sum, the G-pixel data sum and the B-pixel data sum with a first, a second and a third parameters respectively and adding them up to obtain a gamma indication value, and choosing a suitable one from the plurality of gamma reference voltages to display the present frame thereby if the gamma indication value is equal to a gamma reference value formed by adding the first, the second and the third parameters up.

### CROSS-REFERENCE TO RELATED APPLICATION

This application is a continuation application of and claims the priority benefit of a prior application Ser. No. 11/393,238, filed on Mar. 30, 2006, now pending. The entirety of the above-mentioned patent application is hereby incorporated by reference herein and made a part of this specification.

### BACKGROUND OF THE INVENTION

1. Field of the Invention

The present invention relates to a dynamic gamma control method for an LCD, and more particularly to a method for image contrast enhancement by controlling gamma curve in TFT-LCD.

2. Background of the Invention

TFT-LCDs are becoming suitable display devices for digital TVs because of their low power consumption, light and slim design, high image quality and even large-size capability. In recent years, people have more opportunities to enjoy moving picture images. To obtain improved image quality of moving pictures, it is necessary to apply image enhancement technology to TFT-LCDs.

Several years ago, there had been very limited attempt to achieve image enhancement without any data modification because gamma voltages of an LCD is unchangeable. Please refer to FIG. 1, which is a block diagram showing a gamma reference voltage generation circuit of a conventional LCD according to the prior art. In FIG. 1, the gamma reference voltage generation circuit 1 includes an ASIC (Application Specific Integrated Circuit) block 10, a resistor string (R-String) and buffer block 11, and a source ICs block 12. The ASIC at least includes an LVDS (Low Voltage Differential Signaling) circuit 101 and timing controller 102, which are used for performing the normal function of the ASIC block 10. The R-String 11 is a voltage divider which is composed of serially connected resistors between a high and a low voltage sources (not shown).

The generation of the gamma reference voltages in the conventional gamma reference voltage generation circuit 1 is an analog process. The ASIC block 10 receives the input data and outputs the display data to the source ICs block 12. The voltage difference between the high and the low voltage sources is divided by the R-String 11 so that the gamma reference voltages are obtained analogically. The gamma reference voltages are then sent to the source ICs block 12. In the configuration shown in FIG. 1, there is no way to change gamma voltages after setting the R-String 11.

Dynamic gamma control (DGC) is the first attempt to improve image quality without data manipulation. Conceptually, DGC changes gamma curve adaptively and automatically by modifying gamma voltages of an LCD. Please refer to FIG. 2, which is a block diagram showing a gamma reference voltage generation circuit with DGC technique of another conventional LCD according to the prior art.

Similar to the circuit in FIG. 1, the gamma reference voltage generation circuit 2 in FIG. 2 includes an ASIC block 20 and a source ICs block 22. However, the differences between the circuits in FIG. 1 and in FIG. 2 are the introduction of a histogram extraction 203 into the ASIC block 20 and the replacement of a multi-channel DAC (digital-to-analog converter) block 21 for the R-String 11. According to DGC composed of the histogram extraction and the gamma voltage manipulation, by means of the multi-channel DAC block 21 with serial digital interface shown in FIG. 2, the gamma voltages can be easily changed frame by frame.

The key to the gamma reference voltage generation circuit 2 in FIG. 2 to achieve dynamic gamma control is to obtain a specific algorithm for deciding when to switch the frames. The algorithm adopted by the gamma circuit in FIG. 2 is the histogram extraction technique. Specifically, the histogram extraction 203 is based on the requirement for an enough large frame memory which is used for accumulating the data of the previous frame and providing some information for deciding when to switch.

It is therefore attempted by the applicant to provide a novel algorithm which is able to achieve DGC without the usage of the frame memory.

### SUMMARY OF THE INVENTION

It is therefore the first aspect of the present invention to provide a dynamic gamma control method for an LCD. A gamma reference voltage generation circuit equipped with the dynamic gamma control is able to decide when to switch the frames by the equation of luminance of LCD: Y=X₁R+X₂G+X₃B, wherein Y is a gamma indication value, X₁, X₂ and X₃ are three parameters, and R, G and B are an R-pixel data sum, a G-pixel data sum and a B-pixel data sum of the present frame respectively. With the dynamic gamma control, the gamma voltages of the LCD can be easily changed frame by frame without the need of the frame memory to achieve DGC.

It is therefore the second aspect of the present invention to provide a dynamic gamma control method for an LCD, wherein the LCD displays a present frame by a plurality of gamma reference voltages, and the present frame includes an R-pixel data sum, a G-pixel data sum and a B-pixel data sum which are obtained by respectively adding all R-pixel data, all G-pixel data and all B-pixel data of at least one pixel of the present frame, including steps of: weighting the R-pixel data sum, the G-pixel data sum and the B-pixel data sum with a first, a second and a third parameters respectively and adding them up to obtain a gamma indication value, and choosing a suitable one from the plurality of gamma reference voltages to display the present frame thereby if the gamma indication value is equal to a gamma reference value formed by adding the first, the second and the third parameters up.

It is therefore the third aspect of the present invention to provide a dynamic gamma control method for an LCD displaying a present frame by a plurality of gamma reference voltages, including steps of: obtaining an R-pixel data sum, a G-pixel data sum and a B-pixel data sum by respectively adding all R-pixel data, all G-pixel data and all B-pixel data of at least one pixel of the present frame, weighting the R-pixel data sum, the G-pixel data sum and the B-pixel data sum with a first, a second and a third parameters respectively and adding them up to obtain a gamma indication value, and choosing a suitable one from the plurality of gamma reference voltages to display the present frame thereby if the gamma indication value is equal to a gamma reference value formed by adding the first, the second and the third parameters up.

It is therefore the fourth aspect of the present invention to provide a dynamic gamma control method for an LCD displaying a present frame by a plurality of gamma reference voltages, including steps of: obtaining an R-pixel data sum, a G-pixel data sum and a B-pixel data sum by respectively adding all R-pixel data, all G-pixel data and all B-pixel data of all pixels of the present frame, weighting the R-pixel data sum, the G-pixel data sum and the B-pixel data sum with a first, a second and a third parameters respectively and adding them up to obtain a gamma indication value, and choosing a suitable one from the plurality of gamma reference voltages to display the present frame thereby if said gamma indication value is equal to a gamma reference value formed by adding the first, the second and the third parameters up.

Preferably, the LCD is a TFT-LCD.

Preferably, the LCD includes an application specific integrated circuit (ASIC) for operating the dynamic gamma control method.

Preferably, the ASIC further includes a low voltage differential signaling (LVDS) circuit and a timing controller.

Preferably, the LCD further includes a multi-channel digital-to-analog converter (DAC) for receiving the gamma indication value and sending the suitable gamma reference voltage.

Preferably, the LCD further includes a driver IC for driving the LCD by the suitable gamma reference voltage.

The foregoing and other features and advantages of the present invention will be more clearly understood through the following descriptions with reference to the drawings, wherein:

### BRIEF DESCRIPTION OF THE DRAWINGS

FIG. 1 is a block diagram showing a gamma reference voltage generation circuit of a conventional LCD according to the prior art;

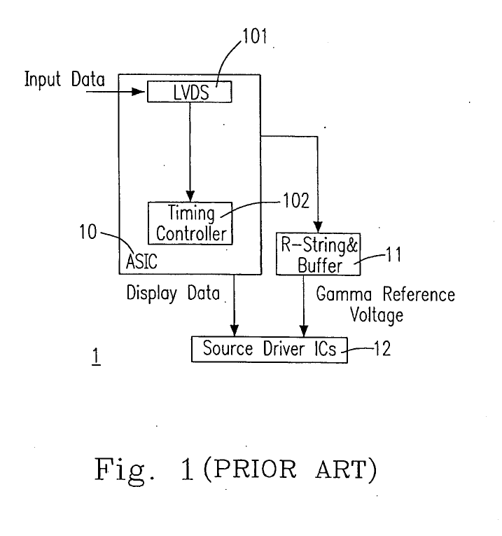

FIG. 2 is a block diagram showing a gamma reference voltage generation circuit with DGC technique of another conventional LCD according to the prior art;

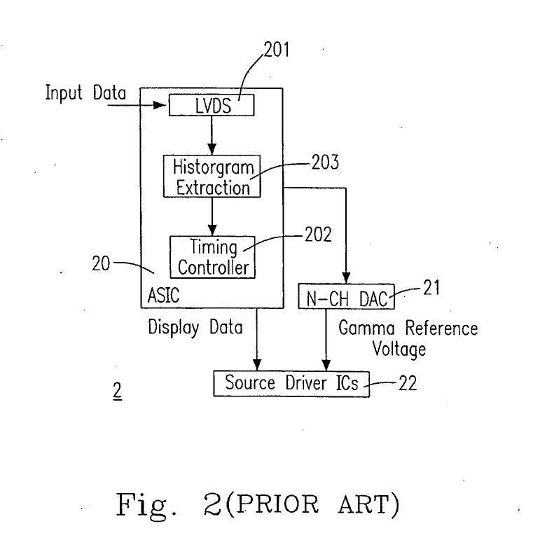

FIG. 3 (a) is a block diagram showing a gamma reference voltage generation circuit with DGC technique of the LCD according to the present invention; and

FIG. 3 (b) is a diagram showing 25 pixels of the frame weighted by the DGC block in FIG. 3 (a) according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

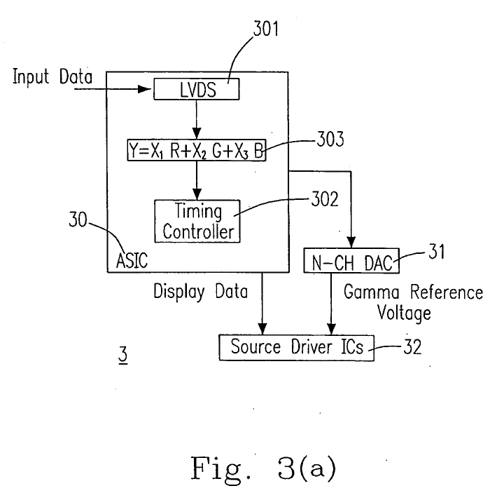

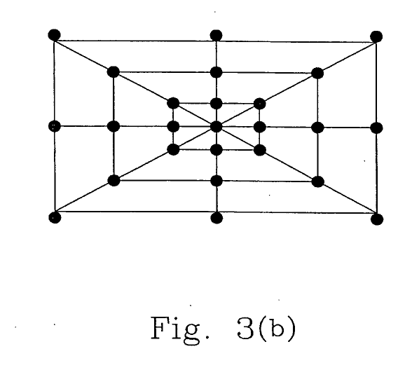

Please refer to FIG. 3 (a), which is a block diagram showing a gamma reference voltage generation circuit with DGC technique of the LCD according to the present invention. In FIG. 3 (a), the gamma reference voltage generation circuit 3 includes an ASIC (Application Specific Integrated Circuit) block 30, a multi-channel DAC (digital-to-analog converter) block 31, and a source ICs block 32. Similar to the prior art, the ASIC block 30 at least includes an LVDS (Low Voltage Differential Signaling) circuit 301 and timing controller 102, which are used for performing the normal function of the ASIC block 30. Specifically, the technical feature of the present invention is to provide an algorithm block 303 which operates by an algorithm: the equation of luminance of LCD: Y=X₁R+X₂G+X₃B. In details, Y is a gamma indication value. X₁, X₂ and X₃ are three parameters decided by a user by his own choice. R, G and B are an R-pixel data sum, a G-pixel data sum and a B-pixel data sum obtained by respectively adding all R-pixel data, all G-pixel data and all B-pixel data of at least one pixel of the present frame of the LCD.

As mentioned before, the ASIC block 30 receives the input data and outputs the display data to the source ICs block 32. The voltage difference between the high and the low voltage sources is modulated by the multi-channel DAC block 31 so that the gamma reference voltages are obtained and changed dynamically. The gamma reference voltages are then sent to the source ICs block 32 for the image enhancement.

The operation principle of the algorithm block 303 is descript as follows. In the algorithm block 303, according to the equation of luminance of LCD: Y=X₁R+X₂G+X₃B, the R-pixel data sum R, the G-pixel data sum G and the B-pixel data sum B are weighted by a first parameter X₁, a second parameter X₂ and a third parameter X₃ respectively, i.e. R=Σrₙ, G=Σgₙ and B=Σbₙ. After the weighting process, they are then added up to obtain the gamma indication value Y. For the propose of the best mode, it is assumed that a gamma reference value formed by adding the first, the second and the third parameters X₁ X₂ and X₃ exists. As soon as the gamma indication value Y reaches the gamma reference value, a suitable gamma reference voltage is chosen from the plurality of the gamma reference voltages and then sent to the source ICs block 32 to drive the LCD. Hence, the LCD displays the present frame with a better image contrast enhancement.

### (1) EMBODIMENT 1

In general, the vision of a human to the green light is the sharpest than to other colors. So the weight, i.e. the second parameter X₂, of the G-pixel data sum G can be set larger than the others. The first, the second and the third parameters X₁ X₂ and X₃ are assumed that they are 0.3, 0.59 and 0.11 respectively and then the algorithm equation of the block 303 is Y=0.3R+0.59G+0.11B. For the best mode, the gamma reference value is 1(=0.3+0.59+0.11). In the present frame, several pixels are appointed. Then the R-pixel data, G-pixel data and B -pixel data of the pixels are accumulated to generate the gamma indication value according to the above equation. When the gamma indication value is detected to reach the gamma reference value 1, the decision is made to decide when to switch from the present frame to the next frame. Accordingly, the dynamic gamma control of the LCD is achieved.

### (2) EMBODIMENT 2

Please refer to FIG. 3 (b), which is a diagram showing 25 pixels of the frame weighted by the DGC block in FIG. 3 (a) according to the present invention. The first, the second and the third parameters X₁ X₂ and X₃ in this embodiment are assumed that they are 3, 6 and 1 respectively and then the algorithm equation of the block 303 is Y=3R+6G+1B. For the best mode, the gamma reference value is 10(=3+6+1). In the present frame, 25 pixels are appointed. Then the R-pixel data, G-pixel data and B-pixel data of the pixels are accumulated to generate the gamma indication value according to the above equation. When the gamma indication value is detected to reach the gamma reference value 10, the decision is made to decide when to switch from the present frame to the next frame. Accordingly, the dynamic gamma control of the LCD is achieved.

In the above embodiments, the number of the appointed pixels and the amount of the three parameters are determined by the need of the user. Depending on the need, a part of the pixels or all pixels of the present frame are appointed and summed. With the

DGC method provided by the present invention, the gamma voltages of the LCD can be easily changed frame by frame without the need of the frame memory to achieve DGC and the cost is hence reduced.

In conclusion, a gamma reference voltage generation circuit equipped with the dynamic gamma control is able to decide when to switch the frames by the equation of luminance of LCD: Y=X₁R+X₂G+X₃B, wherein Y is a gamma indication value, X₁, X₂ and X₃ are three parameters, and R, G and B are an R-pixel data sum, a G-pixel data sum and a B-pixel data sum of the present frame respectively. With the dynamic gamma control, the gamma voltages of the LCD can be easily changed frame by frame for image contrast enhancement by controlling gamma curve in LCD and without the need of the frame memory.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A dynamic gamma control method, suitable for a liquid crystal display (LCD), the dynamic gamma control method comprising:
receiving input data of a present frame, and providing a plurality of different first gamma reference voltages for the present frame to a source driver IC;
analyzing only a part of the input data uniformly distributing on the present frame by an equation of luminance of the LCD under a condition of without using a frame memory, so as to obtain a gamma indication value;
determining whether the gamma indication value is equal to a predetermined value; and
if the gamma indication value is equal to the predetermined value, changing the first gamma reference voltages, so as to obtain and provide a plurality of different second gamma reference voltages for a next frame to the source driver IC, thereby the present frame and the next frame are corresponding to two different gamma curves.

2. The dynamic gamma control method according to claim 1, wherein the first gamma reference voltages are corresponding to a first gamma curve from one of the two different gamma curves, and the second gamma reference voltages are corresponding to a second gamma curve from the other of the two different gamma curves.

3. The dynamic gamma control method according to claim 1, further comprising:
if the gamma indication value is not equal to the predetermined value, maintaining the first gamma reference voltages for the next frame, thereby the present frame and the next frame are corresponding to a same gamma curve.

4. The dynamic gamma control method according to claim 1, wherein the part of the input data comprises:
a part of red pixel data of the present frame;
a part of green pixel data of the present frame; and
a part of blue pixel data of the present frame.

5. The dynamic gamma control method according to claim 4, wherein the equation of luminance of the LCD is Y=X₁R+X₂G+X₃B, where Y is the gamma indication value, X₁ to X₃ are three user defined parameters, R is a sum of the red pixel data, G is a sum of the green pixel data, and B is a sum of the blue pixel data.

6. The dynamic gamma control method according to claim 5, wherein X₂ is greater than X₁ and X₃.

7. A dynamic gamma control apparatus, suitable for a liquid crystal display (LCD), the dynamic gamma control apparatus comprising:
an application specific integrated circuit (ASIC), receiving input data of a present frame, and analyzing only a part of the input data uniformly distributing on the present frame by an equation of luminance of the LCD under a condition of without using a frame memory, so as to obtain a gamma indication value; and
a multi-channel digital-to-analog converter (DAC), coupled to the ASIC, providing a plurality of different first gamma reference voltages for the present frame to a source driver IC,
wherein the ASIC further determines whether the gamma indication value is equal to a predetermined value, and
if the gamma indication value is equal to the predetermined value, the ASIC changes the first gamma reference voltages provided by the multi-channel DAC, so as to make the multi-channel DAC converter obtain and provide a plurality of different second gamma reference voltages for a next frame to the source driver IC, thereby the present frame and the next frame are corresponding to two different gamma curves.

8. The dynamic gamma control apparatus according to claim 7, the first gamma reference voltages are corresponding to a first gamma curve from one of the two different gamma curves, and the second gamma reference voltages are corresponding to a second gamma curve from the other of the two different gamma curves.

9. The dynamic gamma control apparatus according to claim 7, if the gamma indication value is not equal to the predetermined value, the ASIC maintains the first gamma reference voltages provided by the multi-channel DAC for the next frame, thereby the present frame and the next frame are corresponding to a same gamma curve.

10. The dynamic gamma control apparatus according to claim 7, wherein the part of the input data comprises:
a part of red pixel data of the present frame;
a part of green pixel data of the present frame; and
a part of blue pixel data of the present frame.

11. The dynamic gamma control apparatus according to claim 10, wherein the equation of luminance of the LCD is Y=X₁R+X₂G+X₃B, where Y is the gamma indication value, X₁ to X₃ are three user defined parameters, R is a sum of the red pixel data, G is a sum of the green pixel data, and B is a sum of the blue pixel data.

12. The dynamic gamma control apparatus according to claim 11, wherein X₂ is greater than X₁ and X₃.
